(19) United States
(12) Patent Application Publication
(10) Pub. No.: US 2026/0169347 A1
(43) Pub. Date: Jun. 18, 2026

(54) PASSIVE DUAL-AXIS BEAM STEERING FOR OPTICAL PHASED ARRAY

(71) Applicant: The Regents of the University of Michigan, Ann Arbor, MI (US)

(72) Inventors: Venus Kakdarvishi, Dearborn, MI (US); Ya Sha Yi, Troy, MI (US)

(21) Appl. No.: 19/419,949

(22) Filed: Dec. 15, 2025

Related U.S. Application Data
(60) Provisional application No. 63/734,105, filed on Dec. 14, 2024.

(51) Int. Cl. G02F 1/29

(52) U.S. Cl. CPC G02F 1/292

(57) ABSTRACT

An optical phased array (OPA), OPA device, lidar device, and method of manufacturing an OPA are provided. The OPA comprises a first waveguide layer and a second waveguide layer. Each of the first waveguide layer and the second waveguide layer has a single-mode common waveguide path connected to a plurality of emitters. The single-mode common waveguide path of the second waveguide layer is delayed relative to the single-mode common waveguide path of the first waveguide layer.

### TECHNICAL FIELD

This disclosure relates to photonic integrated circuits (PICs) and, more particularly, to solid-state optical phased arrays and devices incorporating an optical phased array (OPA), such as those used for light detection and ranging (LiDAR or lidar).

### BACKGROUND

Optical phased arrays (OPAs) have transformed the control and steering of light beams across various advanced applications, including free-space optical communication, holographic displays, imaging, and LiDAR, for example. OPAs are used in various devices to guide light (including, for example, infrared and/or near-infrared electromagnetic radiation), such as for use in lidar applications, and are coupled to a light source and/or a light sensor so that waveguides or waveguide paths within the OPA guide light appropriately between a collector side (at which the light source/light sensor is/are located) and an emitter side (at which emitting or firing portions, referred to as emitters, are located). At the emitter side, light passes between the OPA and the atmosphere (or another medium). It will be appreciated that the term “light” is used herein in the context of optical phased arrays and this includes non-visible light used by LiDAR and other OPA applications or devices—for example, in the context of LiDAR, a broader spectrum than just visible light is commonly used, such as electromagnetic radiation having infrared and ultraviolet wavelengths and, unless expressly provided for otherwise, the term “light,” as used herein, includes all such types of electromagnetic radiation.

LiDAR systems are used primarily for full dimensional sensing, with applications ranging from navigation for autonomous vehicles to robotics, imaging, unmanned aerial vehicles (UAVs), national security, healthcare, and the Internet of Things (IOTs). With the time of flight (ToF) or frequency modulated continuous wave (FMCW) mechanism, a LiDAR system can generate a three dimensional (3D) map of its surroundings with distance and velocity information. Compared to the common mechanical LiDAR, which is usually a high cost and slow in scanning, a chip-scale LiDAR system can provide both increased range and resolution required for high-speed driving—and other tasks, such as real-time facial recognition—that are beyond the capability of current LiDAR systems. With the growing interest from the research community in chip-scale LiDAR, beam steering (or “beamsteering”) based on integrated OPA technology has drawn a lot of research effort in the past decade.

As a result of advancements made in the electronic integrated circuit (IC) industry, photonic integrated circuits (PIC) were proposed as the next-generation chips and studied for decades. Normal or typical PICs are manufactured using techniques drawn from the mature complementary-metal-oxide semiconductor (CMOS) fabrication process developed for electronic ICs, and such PICs usually have a single waveguide layer on the top of a silicon-on-insulator (SOI) platform (typically, as a disclike wafer) or are based on deposited silicon nitride (Si₃N₄). Usually, the fabrication uses the top layer as the waveguide layer, and then the electronic contacts are fabricated above the waveguides for the modulation. While this technique takes some advantages from the mature CMOS fabrication process used in the IC industry, it restricts the PICs to the single-waveguide-layer configuration, limiting the device's performance and/or features. In recent years, the electronic IC industries have exhibited a trend of converting memory and computing unit designs from 2D to 3D. Nevertheless, these fabrication processes can also be applied to 3D multi-waveguide-layer PICs.

A 3D OPA having multiple waveguide layers generally includes a plurality of one-dimensional arrays of emitters (in a line) with spacing between adjacent emitters. The emitters each terminate at an edge or end surface of the SOI platform. These emitters, which may be referred to each as an “edge-firing emitter”, can be fabricated through generating a pattern layer and a cladding layer (collectively, the pattern layer and cladding layer are referred to as a waveguide-cladding layer) on a base substrate. An edge-firing OPA capable of steering and/or sensing light in three dimensions (referred to as a three-dimensional (3D) OPA) may be manufactured by stacking multiple waveguide layers on top of one another.

OPA technologies leverage diverse mechanisms to achieve precise beam steering, with notable implementations including Liquid Crystal OPAs, Microelectromechanical Systems (MEMS) OPAs, Silicon Photonic OPAs (commonly referred to as solid-state OPAs), Electro-Optic Polymer OPAs, Acousto-Optic OPAs, and Plasmonic OPAs.

To achieve beam steering in solid-state OPAs—referred to as OPAs for simplicity hereafter—phase shifters are essential, which can be either active or passive. Active phase shifters, which often utilize the electro-optic or thermo-optic effect to modulate the light's phase, typically suffer from high power consumption. Moreover, OPAs require high-speed continuous beam steering. Architectures based on active phase shifters employ lookup tables to determine the appropriate signal for each beam angle. In such setups, continuous steering necessitates a stabilization delay for the phase shifters at each step of the sweep. This significantly prolongs the sweep time, as it depends on both the number of angular steps and the necessary relaxation time for each step. Therefore, developing a passive phase shifter solution is desirable in order for enhancing both efficiency and performance.

Traditional single-layer OPA configurations with an M×N array require M×N active phase shifters for two-dimensional (2D) steering. However, by employing grating couplers, 2D steering can be achieved using only M phase shifters combined with wavelength tuning. Despite this advantage, these designs still face limitations in efficiently steering light across multiple dimensions, resulting in increased complexity and potential inefficiencies. Typically, such systems achieve one-dimensional steering through phased array principles, with the orthogonal direction managed via wavelength tuning, further complicating the design.

The emitter part (or emitters) in OPAs can be either end-fire (device edge) or grating couplers. Single-layer OPA configurations with grating emitters typically suffer from substrate leakage, resulting in energy loss due to downward coupling from the grating structure. This inefficiency restricts the effective steering of light beams, limiting the array's functionality. Additionally, diffraction complicates OPA design optimization, as achieving desired beam convergence requires precise control over the grating period to ensure constructive interference.

To mitigate crosstalk within OPAs, designs often employ strategies to suppress inter-waveguide interference, though these methods can increase device complexity. For example, using waveguides with varying widths facilitates the realization of an end-fire array, but applying this to a waveguide grating coupler configuration presents challenges, particularly in achieving a 2D converged beam.

Furthermore, when light is emitted from the top of a grating device, reflections at various interfaces, such as the air-device boundary, can reduce the emitter's efficiency. To mitigate this issue, anti-reflection coatings are commonly applied, requiring an additional step in the fabrication process. Achieving a narrower Full Width at Half Maximum (FWHM) for a smaller beam width typically requires a longer grating structure, but this spreads power along its length, reducing edge power density and overall emitter intensity.

On the other hand, single-layer end-fire OPAs represent another type of emitter, producing a stripe-like (fan) beam, which limits steering capability to a single dimension. As previously noted, most studies have employed active phase shifters combined with grating couplers for 2D beam steering. However, previous works introduced the use of delay lines alongside grating couplers to implement fully passive phase shifters. Despite this advancement, the approach still faces limitations due to the inherent drawbacks of grating couplers.

### SUMMARY

In accordance with a first aspect of the invention, there is provided an optical phased array (OPA), comprising a first waveguide layer and a second waveguide layer. Each of the first waveguide layer and the second waveguide layer has a single-mode common waveguide path connected to a plurality of emitters. The single-mode common waveguide path of the second waveguide layer is delayed relative to the single-mode common waveguide path of the first waveguide layer.

According to various embodiments of the first aspect of the invention, the OPA further includes any one of the following features or any technically-feasible combination of some or all of these features:
an inter-emitter delay is provided between adjacent ones of the plurality of emitters of the second waveguide layer so as to cause a phase shift between the adjacent ones of the plurality of emitters;
the single-mode common waveguide path of the first waveguide layer is a no-delay single-mode common waveguide path;
the single-mode common waveguide path of the second waveguide layer is a delay single-mode common waveguide path that is delay according to a first delay amount;
a third waveguide layer having a single-mode common waveguide path connected to a plurality of emitters;
the second waveguide layer is interposed in a stacked manner between the first waveguide layer and the third waveguide layer;
the single-mode common waveguide path of the third waveguide layer is a delay single-mode common waveguide path that is delay according to a second delay amount that is more than the first delay amount; and/or
the single-mode common waveguide path of the second waveguide layer includes an extended delay line that extends in a second direction orthogonal to the first direction.

In accordance with a second aspect of the invention, there is provided an OPA comprising: a first waveguide layer having a first plurality of emitters arranged in a linear array with each emitter of the first plurality of emitters being in optical communication with a common waveguide path of the first waveguide layer via an individual waveguide path of the first waveguide layer; and a second waveguide layer having a second plurality of emitters arranged in a linear array with each emitter of the second plurality of emitters being in optical communication with a common waveguide path of the second waveguide layer via an individual waveguide path of the second waveguide layer. The common waveguide path of the second waveguide layer is delayed relative to the common waveguide path of the first waveguide layer.

According to various embodiments of the second aspect of the invention, the OPA is characterized according to the OPA of the first aspect of the invention and, in various embodiments, includes any one of the foregoing features or any technically-feasible combination of some or all of these features discussed in connection with the OPA of the first aspect of the invention.

In accordance with a third aspect of the invention, there is provided an OPA comprising a plurality of waveguide layers used for forming a two-dimensional emitter array at a common edge or side of the OPA. The OPA is configured with a first steering angle for steering light in a first direction and a second steering angle for steering light in a second direction. The first direction is orthogonal to the second direction, and the first steering angle and the second steering angle at each at least 35 degrees.

According to various embodiments of the third aspect of the invention, the OPA is characterized according to the OPA of the first aspect of the invention and, in various embodiments, includes any one of the foregoing features or any technically-feasible combination of some or all of these features discussed in connection with the OPA of the first aspect of the invention.

According to various embodiments of the third aspect of the invention, the OPA further includes any one of the following features or any technically-feasible combination of some or all of these features:
the first steering angle is at least 38 degrees;
the second steering angle is at least 70 degrees; and/or
the second steering angle is at least 85 degrees.

In accordance with a fourth aspect of the invention, there is provided a method of manufacturing an OPA, comprising: identifying whether a negative vertical phase profile or a positive vertical phase profile is to be used; determining a common waveguide path delay amount of a common waveguide path of a second waveguide layer based on whether a negative vertical phase profile or a positive vertical phase profile is to be used, wherein the common waveguide path delay amount of a second waveguide layer is an indication of an amount of delay experienced between light travelling through the common waveguide path of the second waveguide layer and light travelling through the common waveguide path of the first waveguide layer; and manufacturing an OPA according to the common waveguide path delay amount.

According to various embodiments of the fourth aspect of the invention, the OPA is characterized according to the OPA of the first, second, and/or third aspects of the invention and, in various embodiments, includes any one of the foregoing features or any technically-feasible combination of some or all of these features discussed in connection with the OPA of the first, second, and/or third aspects of the invention.

In accordance with a fifth aspect of the invention, there is provided an OPA device having the OPA of the first, second, third, and/or fourth aspects of the invention, and the OPA may include any one of the foregoing features or any technically-feasible combination of some or all of these features discussed in connection with the OPA of the first, second, third, and/or fourth aspect of the invention.

In accordance with a sixth aspect of the invention, there is provided a lidar device comprising the OPA of the first, second, third, and/or fourth aspects of the invention, and the OPA may include any one of the foregoing features or any technically-feasible combination of some or all of these features discussed in connection with the OPA of the first, second, third, and/or fourth aspects of the invention.

In accordance with a seventh aspect of the invention, there is provided a lidar device comprising: an optical phased array (OPA) having a first waveguide layer and a second waveguide layer; an optical fiber for coupling to the OPA so as to be in optical communication with a common path of each of the first waveguide layer and the second waveguide layer; and a light sensor coupled to the optical fiber and configured for optical communication with the plurality of emitters of each of the first waveguide layer and the second waveguide layer. Light propagating through the common path of the second waveguide layer is delayed relative to light propagating through the common path of the first waveguide layer.

According to various embodiments of the third aspect of the invention, the OPA is characterized according to the OPA of the first, second, third, and/or fourth aspects of the invention and, in various embodiments, includes any one of the foregoing features or any technically-feasible combination of some or all of these features discussed in connection with the OPA of the first, second, third, and/or fourth aspects of the invention.

### BRIEF DESCRIPTION OF THE DRAWINGS

Preferred exemplary embodiments will hereinafter be described in conjunction with the appended drawings, wherein like designations denote like elements, and wherein:

FIG. 1 depicts an optical phased array (OPA) device having an OPA with an on-chip edge coupler and a plurality of waveguide layers including a top waveguide layer, according to one embodiment;

FIG. 2 depicts a waveguide layer that is formed from a Silicon-based structure, such as, for example, a Silicon-on-insulator (SOI) platform, and that may be used as a part of the OPA of FIG. 1, according to one embodiment;

FIG. 3 depicts a plan view of the waveguide layer of FIG. 2 with an expanded portion of a tree splitter or multimode interferometer (MMI), according to one embodiment;

FIG. 4 depicts an expanded portion of an inter-emitter phase delay modulator or phase shifter portion (referred to also as an individual waveguide delay portion) that may be used as a part of the waveguide layer of FIG. 2, according to one embodiment;

FIG. 5 depicts a peripheral plan view of a three-dimensional (3D) edge-firing OPA, particularly showing an emitter side surface of the OPA, according to one embodiment;

FIG. 6 depicts a peripheral plan view of the 3D edge-firing OPA of FIG. 5, particularly showing a collector side surface of the OPA, according to one embodiment;

FIG. 7 depicts a single-mode common waveguide configuration, which may be used for a path of a first waveguide layer of an OPA, such as the OPA of FIG. 1, according to one embodiment;

FIG. 8 depicts a single-mode common waveguide configuration, which may be used for a path of a second waveguide layer of an OPA, such as the OPA of FIG. 1, according to one embodiment;

FIG. 9 depicts a single-mode common waveguide configuration, which may be used for a path of a third waveguide layer of an OPA, such as the OPA of FIG. 1, according to one embodiment;

FIG. 10 depicts a single-mode common waveguide configuration, which may be used for a path of a fourth waveguide layer of an OPA, such as the OPA of FIG. 1, according to one embodiment;

FIG. 11 depicts a single-mode common waveguide configuration, which may be used for a path of a fifth waveguide layer of an OPA, such as the OPA of FIG. 1, according to one embodiment;

FIG. 12 depicts a single-mode common waveguide configuration, which may be used for a path of a sixth waveguide layer of an OPA, such as the OPA of FIG. 1, according to one embodiment;

FIG. 13 depicts a single-mode common waveguide configuration, which may be used for a path of a seventh waveguide layer of an OPA, such as the OPA of FIG. 1, according to one embodiment;

FIG. 14 depicts a single-mode common waveguide configuration, which may be used for a path of an eighth waveguide layer of an OPA, such as the OPA of FIG. 1, according to one embodiment;

FIG. 15 depicts a isometric view of an OPA including the first through eight waveguide layers of FIGS. 7-14, according to one embodiment;

FIG. 16 is a graph illustrating exemplary results of sidelobe level for an OPA according to embodiments of the present disclosure;

FIG. 17 is a graph illustrating exemplary farfield in both two-dimensional (2D) and 3D perspectives for a 1500 nm wavelength, according to one embodiment;

FIG. 18 is a graph of wavelength (in nm) (on the x axis) and farfield angle (in degrees) (on the y axis), according to one embodiment;

FIG. 19 is a plan view of an inter-emitter delay portion of a different first and a last waveguide layer for a positive slope, according to one embodiment;

FIG. 20 is a plan view of an inter-emitter delay portion of a different first and a last waveguide layer for a positive slope, according to one embodiment;

FIGS. 21 and 22A-B each is an isometric view of an individual waveguide delay portion of a positive-slope 3D OPA in which a plurality of individual waveguide paths are shown for each of the M waveguide layers, which is 8 (M=8) in the depicted embodiment of FIGS. 21 and 22;

FIG. 23A depicts an isometric view of a vertical delay line, corresponding to delay in a third dimension, according to one embodiment;

FIG. 23B depicts an isometric view of a horizontal delay line, corresponding to delay in a first dimension, according to one embodiment;

FIG. 24 is a graph illustrating a function value for each of about 450 iterations of a particle swarm optimization (PSO), according to one embodiment;

FIG. 25 is a spatial graph illustrating emitter positions of an eight (8) waveguide layer OPA, with the x-axis corresponding to a slow axis or horizontal direction (dimension D1) and the y-axis corresponding to a fast axis or vertical direction (dimension D3), according to one embodiment;

FIG. 26 is a spatial graph illustrating emitter positions of an eight (8) waveguide layer OPA, with the x-axis corresponding to a slow axis or horizontal direction (dimension D1) and the y-axis corresponding to a fast axis or vertical direction (dimension D3), according to one embodiment; and

FIG. 27 is a graph, particularly a farfield radiation intensity pattern plot for a 3D OPA operating with a field of view (FOV) angular range of 120°× 60° (120° for horizontal, 60° for vertical).

### DETAILED DESCRIPTION

An optical phased array (OPA), OPA device, and system comprising an OPA device are described herein. The OPA provided herein, according to at least one embodiment, includes a waveguide layer with a common waveguide path that tapers down via a tapered portion, generally from multi to single mode, and then splits or branches via a multimode interferometer (MMI) into a plurality of separate waveguide paths, each of which is terminated at an emitter. Spacing between adjacent emitters within one of the waveguide layer(s) of the OPA is aperiodic in that it exhibits a non-uniform emitter pitch. Further, the OPA includes a common delay path disposed between an end of the tapered portion of the common waveguide path and the MMI (or other waveguide branching portion of the OPA). The common delay path acts to delay light transmitted to each of the emitters of the waveguide layer according to a common delay time. In at least one embodiment, the tapered portion of the waveguide path funnels or otherwise guides the light from multimode to single mode, particularly where the single-mode common waveguide path begins and extends toward the multimode interferometer (MMI).

Aspects of the disclosure further described an OPA constructed from multiple waveguide layers, where at least one of the waveguide layers each includes a common delay path disposed between the tapered portion of the common waveguide path and the MMI of the waveguide layer, as introduced above. In embodiments, multiple waveguide layers employ a common delay path, but where the common delay time varies amongst the waveguide layers. And, in some embodiments, all but one of the waveguide layers includes a common delay path; this one waveguide layer without the common delay path, instead, exhibits a straight or linear path extending from the tapered portion to the MMI.

Aspects of the disclosure are specifically directed to addressing the challenges discussed in the background above through introduction of a purely-passively-controlled-phase-modulation OPA design and configuration, which exhibits those desirable dual-axis OPA beam steering characteristics discussed above without the need for or use of grating couplers by leveraging passive phase shifters based solely on delay lines. According to an embodiment, the design integrates these delay lines both within and between the arrays across individual layers, enabling precise control over phase distribution. That is, to overcome the challenges discussed in the background above, an OPA design that eliminates the need for grating couplers (by utilizing passive phase shifters based solely on delay lines) is provided, according to at least one aspect of the present disclosure. Further, such a design integrates these delay lines both within and between the arrays across individual layers, enabling precise control over phase distribution.

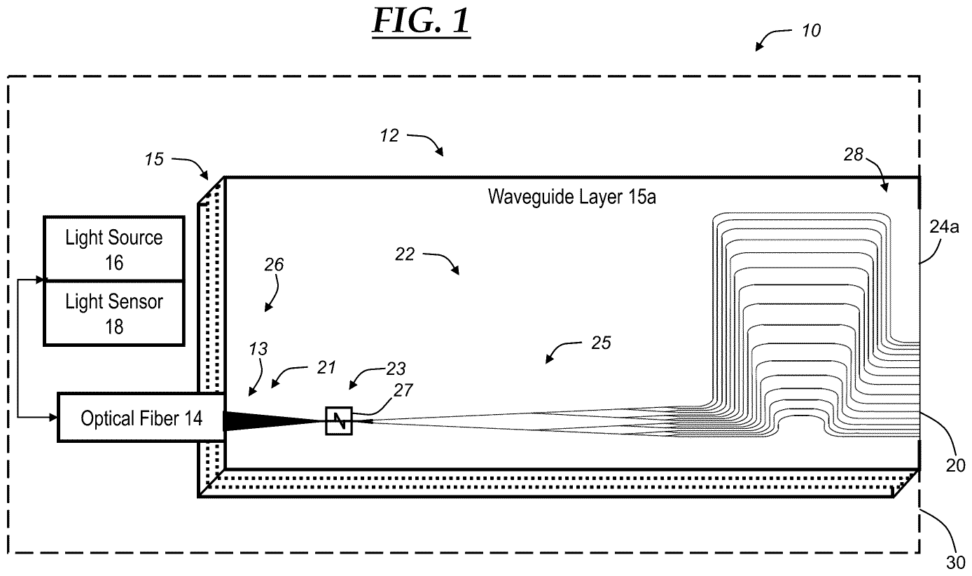

With reference to FIG. 1, there is shown an embodiment of an optical phased array (OPA) device 10 having an OPA 12 with an on-chip edge coupler 13 and a plurality of waveguide layers 15 including a top waveguide layer 15a. The OPA device 10 of the present embodiment further includes an optical fiber 14, a light source 16, and a light sensor 18. An optical phased array device is a device having an optical phased array. The OPA device 10 may be used for a variety of different applications according to various embodiments, such as, for example, a solid-state lidar device, or for a variety of purposes as a part of a photonic integrated circuit (PIC). In at least some embodiments, the OPA device 10 may be used for three-dimensional lidar applications, and/or may enable solid state scanning through varying the time delay of emitted light generated from a coherent light produced by the light source 16, for example. It will be appreciated that the depiction of the OPA device 10 in FIG. 1 is diagrammatic and that the optical phased array device may be incorporated into another device or apparatus, and may be a part of a larger system.

In the depicted embodiment, the top waveguide layer 15a has a 1×16 channel passive sparse aperiodic configuration, where “aperiodic” refers to the non-uniform nature of emitter pitch (spacing between adjacent emitters). The other ones of the waveguide layers 15 each has the same general configuration as the top waveguide layer 15a, although a common delay path is introduced in the other waveguide layers, as discussed below. According to one embodiment, the waveguide layers 15 are each a 1×64 channel passive sparse aperiodic OPA instead of a 1×16 channel passive sparse aperiodic configuration, as shown in the depicted embodiment. Indeed, the OPA 12 may exhibit any of a number of suitable OPA channel configuration, including, for example, those having 2N channels, where N is a positive integer; for example, a 1×8 (N=3) or 1×32 (N=5) channel passive sparse aperiodic configuration is used.

The OPA 12 is shown as being operatively coupled to the light source 16 and the light sensor 18, and may be used to transmit light generated or provided by the light source 16 and to receive light impinged at the OPA 12 at the light sensor 18. The OPA 12 is an edge-firing OPA in that it includes a plurality of edge emitters 20 that are disposed at an edge of a planar structure, such as an edge of a Silicon-based wafer having the plurality of waveguide layers 15 thereon. The OPA 12 may employ a Silicon-based waveguide structure forming a waveguide array and having a Si₃N₄ pattern layer and a SiO₂ base layer, such as that which is disclosed in U.S. Patent Application Publication No. 2021/0271148 A1, the entire contents of which are hereby incorporated by reference and attributed to the OPA 12 to the extent it is not inconsistent with the discussion herein. In embodiments, the components 12-18 of the optical phased array device 10 may be disposed on a common substrate 30, which may be a printed circuit board, according to one embodiment. In other embodiments, the components 12-18 may be arranged or disposed on different substrates and/or housed in different housings, for example.

The on-chip edge coupler 13 is used to couple the optical fiber 14 to the OPA 12, and includes a waveguide edge coupling region 15. The waveguide edge coupling region 15 is a region or portion of a surface of an edge or peripheral side of the OPA 12. As used herein, a “peripheral side” of an OPA refers to a side that is comprised of an edge of each of a plurality of waveguide layers comprising the OPA. The on-chip edge coupler 13 may be, for example, the on-chip edge coupler 13 of the OPA 12 discussed and taught in U.S. Patent Application Publication No. 2025/0067927 A1 (U.S. patent application Ser. No. 18/810,944), the entire contents of which is hereby incorporated by reference.

With reference still to FIG. 1, the plurality of edge emitters 20 are comprised of terminal portions of a waveguide path 22 disposed within the optical phased array 12. The edge emitters 20 are disposed at a common edge 24a and are spaced apart from one another in a first dimension D1. The common edge 24a is disposed on a peripheral side of the OPA 12, and the common edge 24a of the top waveguide layer 15a whereat the plurality of emitters 20 are located for the top waveguide layer 15a, and this edge 24a of the top waveguide layer 15a is flush with. The waveguide path 22 of the top waveguide layer 15a is shown schematically in FIG. 1 as extending from the light source 16 and light sensor 18 to the edge emitters 20 whereby the waveguide path is bifurcated numerous times so as to result in sixteen branched paths, each corresponding to one of the edge emitters 20. As shown in FIG. 1, a collector end or side 26 of the OPA 12 is an end of the OPA 12 whereat the light source 16 and the light sensor 18 are located, and an emitter end or side 28 of the OPA 12 is an end of the OPA 12 whereat the edge emitters 20 are located. The depiction of the waveguide path 22 in FIG. 1 is for purposes of showing which elements are operatively coupled to one another and not for showing actual physical locations, configurations, or shapes of the waveguide paths, which may take a different form.

The waveguide path 22 includes a tapered width portion 21 in which a diameter or width of the waveguide path decreases as it extends from the collector side 26 towards the emitter side 28. In at least some embodiments, including the present embodiment, the tapered width portion 21 provides a tapering of the waveguide path 22 from a multimode configuration to a single-mode configuration in which the only propagating light is light of the lowest-order mode. At the end of the tapered width portion 21 closest the collector side 26, there begins a single-mode common waveguide path 23, extending therefrom towards the emitter side 28 the waveguide path 22 and to a multimode interferometer (MMI) or branching portion 25. Accordingly, the single-mode common waveguide path 23 is a portion of the waveguide path 22 disposed between the tapered width portion 21 and the MMI or branching portion 25.

In the single-mode configuration, a waveguide diameter of around 800 nanometers (nm) or less may be used, but is dependent on the wavelength of the light propagating therethrough, as appreciated in the art. For example, a single-mode common waveguide diameter of 800 nm for the single-mode common waveguide path 23 is suitable for single-mode light propagation at a wavelength of around 1550 nm, provided a refractive index of the core of 1.45 and refractive index of cladding between 1.44.

The single-mode common waveguide path 23 is shown in the depicted embodiment using a symbol comprised of a square with a zigzag therein. This symbol at shown at the single-mode common waveguide path 23 is representative of a portion of the waveguide path 22 that varies amongst the different waveguide layers 15. For example, the top waveguide layer 15a includes a straight or no-delay path for its single-mode common waveguide path 23, whereas the other ones of the waveguide layers 15 include a delay path for each's respective single-mode common waveguide path 23, as discussed more below.

Although it is the top waveguide layer 15a of the OPA 12 that is shown and discussed with regard to the waveguide path 22 disposed therein, and the discussion of the waveguide path 22 is hereby attributed to the other ones of the waveguide layers 15 to the extent such discussion is not inconsistent with the teachings thereof.

A difference between the top waveguide layer 15a and the other waveguide layers 15 is that the waveguide layer 15a is characterizable on the basis that the top waveguide layer 15a includes no delay in the single-mode common waveguide path 23, and this is referred to as a no-delay single-mode common waveguide path 27. Generally, no delay refers to the fact that the light travels through the single-mode common waveguide path 23 of the waveguide layer 15a in a minimal amount of time, extending in a straight line constituting the shortest path between the end of the tapered width portion 21 and the MMI 25.

A no-delay single-mode common waveguide path, such as the path 27, is a portion of a waveguide path (e.g., the waveguide path 22) that exhibits no passive time delay through intentional routing (i.e., travels in a straight line between its start and end) and, as shown in the present embodiment, is characterized in that the path 23 extends in a straight line from the end of the tapered width portion 21 to the MMI 25. This top waveguide layer 15a is an example of a no-common-delay waveguide layer as there is no delay introduced into the common waveguide portion of the waveguide path.

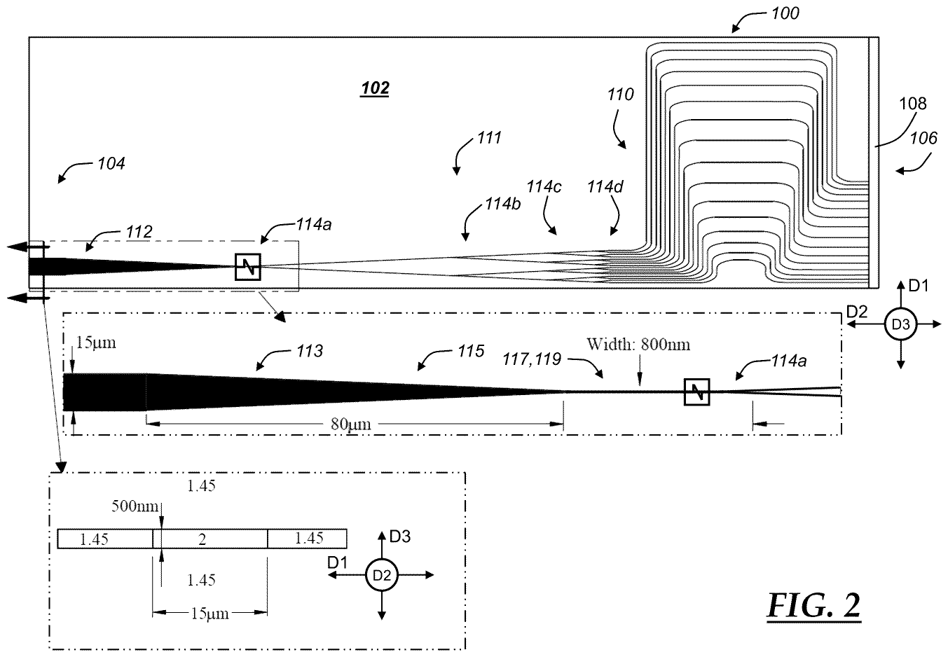

On the other hand, the other ones of the waveguide layers 15 each includes a delay single-mode common waveguide path 29 in which a delay is intentionally introduced and, more particularly, a predetermined delay or length of the delay is introduced so as to cause a predetermined or intentional phase delay between light propagating through the single-mode common waveguide path 23 of those other waveguide layers 15. A delay single-mode common waveguide path (e.g., the path 29 of each of the other ones of the waveguide layers 15) is a portion of a waveguide path (e.g., the waveguide path 22) that exhibits passive time delay through intentional routing (i.e., routing the waveguide at this portion in a non-straight line, such as through use of an omega-shape, as shown in exemplary embodiments of FIGS. 2-4). In the present embodiment, the delay single-mode common waveguide path 29 is characterized in that the path 23 extends in an omega shape. As used herein, the term “omega shape,” when used in connection with a portion of a waveguide path that extends generally in a second direction D2, is a path that curves, bends, or otherwise changes direction to travel in a first direction D1 (orthogonal to the second direction D2), then changes direction toward the second direction D2, continues changing direction (or after extending/travelling in the second direction D1 then) changes direction to travel in the first direction D1 again, and then changes direction one last time so as to travel in the second direction D2.

With reference to FIGS. 2-6, there is shown an exemplary waveguide layer 100 that may be used as any of the one or more waveguide layers 15 of the OPA 12, such as the top waveguide layer 15a and/or each or any number including all of the other waveguide layers 15. In at least one embodiment, each of a plurality of waveguide layers includes a delay of a different amount, including where at least one of the waveguide layers includes no common delay.

With specific reference now to FIG. 2, the waveguide layer 100 is formed from a Silicon-based structure 102, which may be a Silicon-on-insulator (SOI) platform. The waveguide layer 100 has a collector side 104 and an emitter side 106 disposed on an opposite side of the waveguide 100 from the collector side 104. The Silicon-based structure 102 may include a Silicon wafer and a single two-dimensional (2D) waveguide array and, as discussed below, is used in the present embodiment as a part of the top waveguide layer 15a amongst a plurality of waveguide layers.

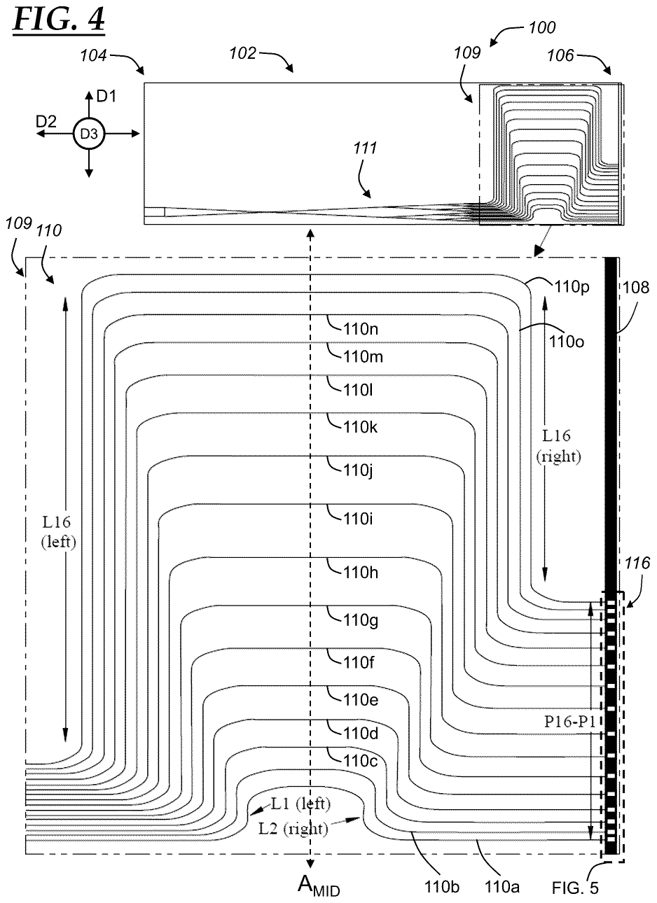

The collector side 104 is configured to be coupled via an optical fiber (e.g., optical fiber 14) to a light source and light sensor, such as the light source 16 and the light sensor 18 when used as the optical phased array 12 in the optical phased array device 10. The waveguide layer 100 includes an edge 108 that extends in the first dimension D1, which is orthogonal to a second dimension D2. The optical phased array 100 includes a plurality or a set of individual waveguide paths (or simply “waveguides”) 110 that extend generally in the second dimension D2 from the collector side 104 to the emitter side 106. Here, the term “individual,” when used in connection with a waveguide layer having a plurality of emitters, refers to a waveguide path that is for a single emitter so that, for example, if there are N emitters, there are N individual waveguide paths. In particular, the set of waveguide paths 110 start at the collector side 104 and all are formed of a single or common path 112, which then splits or branches in a binary fashion multiple times so that N waveguide paths 110 are generated (where N is the number of waveguide paths/emitters). The waveguide paths 110 may each be formed as a 1×N multimode interferometer (MMI) or tree splitter 111, where N is the number of waveguide paths, which is sixteen in the depicted embodiment; specifically, in the embodiment depicted in FIGS. 2-4, each waveguide path 110 begins as a part of the common path 112 and then are split four times, at a first binary split or branching portion 114a, a second binary split or branching portion 114b, a third binary split or branching portion 114c, and a fourth binary split or branching portion 114d, so as to yield sixteen unique waveguide paths 110a-p, as shown in FIG. 4. In other embodiments, a different number N of waveguide paths may be used.

With reference to FIG. 2, namely the expanded plan view of the first binary branching portion 114a and the cross-sectional view of the common path 112, there are shown exemplary dimensions that may be used for the waveguide structure 102. In particular, the common path 112 extends in the second dimension D2 from a first fixed width portion 113 (e.g., connected to the optical fiber 14 via the on-chip edge coupler 13) to a tapered width portion 115 and then to a second fixed width portion 117. The height, taken in the third dimension D3, of the common path 112 is 500 nm, as shown in FIG. 2. The first fixed width portion 113 has a common path start width (taken along dimension D2) of 15 μm; of course, in other embodiments, the common path start width may be larger or smaller, such as, for example, 15 μm+/−8 μm and, preferably in some embodiments, 15 μm+/−3 μm. The tapered width portion 115 of the common path 112 extends, in the second dimension D2, from an end of the first fixed width portion 113 to the second fixed width portion 117, which is referred to as the common path tapered length and is 80 μm in the depicted embodiment; of course, in other embodiments, the common path tapered length may be larger or smaller, such as, for example, 80 μm+/−40 μm and, preferably in some embodiments, 80 μm+/−10 μm.

The second fixed width portion 117 has a fixed diameter or width (taken along the first dimension D1 or the third dimension D3) of 800 nm; of course, in other embodiments, the common path end width may be larger or smaller, such as, for example, 800 nm+/−300 nm and, preferably in some embodiments, 800 nm+/−100 nm. The second fixed width portion 117 extends from an end of the tapered width portion 115 to the first binary split 114a, and this portion 117 corresponds and is coextensive with a single-mode common waveguide path 119, which corresponds to the single-mode common waveguide path 23 of the OPA 12. In previous constructions, such portions 117 are generally short, such as 5 μm or so, particularly where no common delay is desired. However, the single-mode common waveguide path 119 second has a (second dimension) length of at least 50 μm and, in some embodiments, at least 100 μm or even 200 μm, when measured straight in the second direction D2.

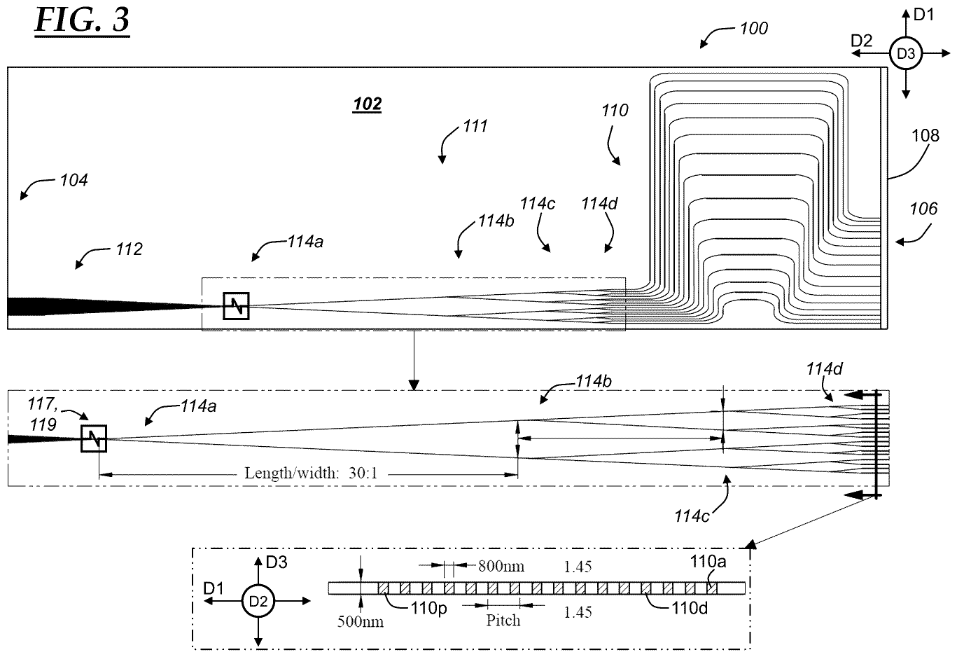

With reference now specifically to FIG. 3, there is shown a plan view of the waveguide layer 100 with an expanded portion of the tree splitter or MMI 111, which includes the four binary branching portions 114a-d. In particular, a first length-width ratio of a first tree branch section (extending in the second dimension D2 between the first and second binary branching portions 114a-b) is 30:1 (length:width), where the length is measured along the second dimension D2 and the width is measured along the first dimension D1 at a portion where the second binary branch section (or second binary branching portion 114b) begins. In at least one embodiment, a second tree branch section (extending from an emitter-side end of the first tree branch section in the second dimension D2 toward the emitter side 106) and a third tree branch section (extending from an emitter-side end of the second tree branch section in the second dimension D2 toward the emitter side 106) may have a second and third length-width ratio, respectively, that is equal to the first length-width ratio, which is 30:1 in the present depicted embodiment. Of course, in other embodiments, the tree splitter 111 may be configured using ratios having different values, such as 20:1 or 40:1, for example.

As shown in the cross-sectional portion of FIG. 3, which is taken at an emitter-side end of the tree splitter 111 where the waveguide paths have been finally split into N separate paths/branches, the height of the waveguide paths 110, taken in the third dimension D3, is 500 nm and the width (taken in the first dimension) of each waveguide path 110a-p is 800 nm. At this portion, each of the waveguide paths 110a-p are separated by a uniform pitch, which may be 2 μm for example; of course, in other embodiments, the pitch may be larger or smaller, such as, for example, 2 μm+/−1.5 μm and/or 2 μm+/−500 nm.

With reference now specifically to FIG. 4, an expanded portion of an inter-emitter phase delay modulator or phase shifter portion 109, also referred to as an individual waveguide delay portion, is shown in which the waveguide paths 110 each extend in a first direction of the second dimension D2 (from the left to right side of FIG. 4) from the tree splitter 111, then extend in a first direction of the first dimension D1 for a length (referred to as a “first leg length”) (such as is indicated at L1 (left) for waveguide path 110a and L16 (left) for waveguide path 110p), then extend in the first direction of the second dimension D2, then in a second direction of the first dimension D1 that is opposite the first direction of the first dimension D1 for a length (referred to as a “second leg length”) (such as is indicated at L1 (right) for waveguide path 110a and L16 (right) for waveguide path 110p), and finally in the first direction of the second dimension D2 at which the waveguide paths 110a-p each end at a respective one of the emitters 116a-p; this configuration is referred to as an omega (Ω) shaped phase delay configuration. According to one embodiment, the first leg length L1 (left) of the first waveguide path 110a is 5 μm and the second leg length L1 (right) of the first waveguide path 110a is 5 μm. The right-angle or 90 degree turns between the first and second dimensions, as shown in the expanded portion of FIG. 4, may each be rounded in a circular manner with a predetermined radius of curvature, such as, for example, 8 μm; in other embodiments, a smaller or larger radius of curvature may be used, such as, for example, 8 μm+/−4 μm and, preferably in some embodiments, 8 μm+/−1 μm. It is noted that the L1 of FIG. 4 is not the same L₁ discussed below in connection with delay line lengths of a first axis (first direction D1).

As shown in FIG. 4, an axis AMID in the first dimension extends through a middle portion of the phase delay modulator or phase shifter portion 109. In at least one embodiment, spacing along this axis AMID is aperiodic such that spacing, in the first dimension, between adjacent waveguide paths is not uniform; this is different from the uniform spacing that is present at the beginning of the phase delay modulator or phase shifter portion 109, which is shown best in cross-section in FIG. 3. In other embodiments, uniform spacing may be used along the axis AMID.

Within the phase delay modulator portion 109, each waveguide path 110a-p has an omega-shaped delay configuration, such as that which is shown in FIG. 4 and described above. In some embodiments, one or more of the waveguide paths 110a-p does not have an omega-shaped delay configuration, such as the first waveguide path 110a, which may simply be a straight path extending in the second dimension D2 from the tree splitter 111 to the emitter 116a; in such embodiments, each of the other waveguide paths 110a-p may have an omega-shaped delay configuration. Each of the waveguide paths 110a-p ends or terminates at the edge 108 at a firing portion at which light is emitted and this portion may be referred to as an edge emitter 116a-p.

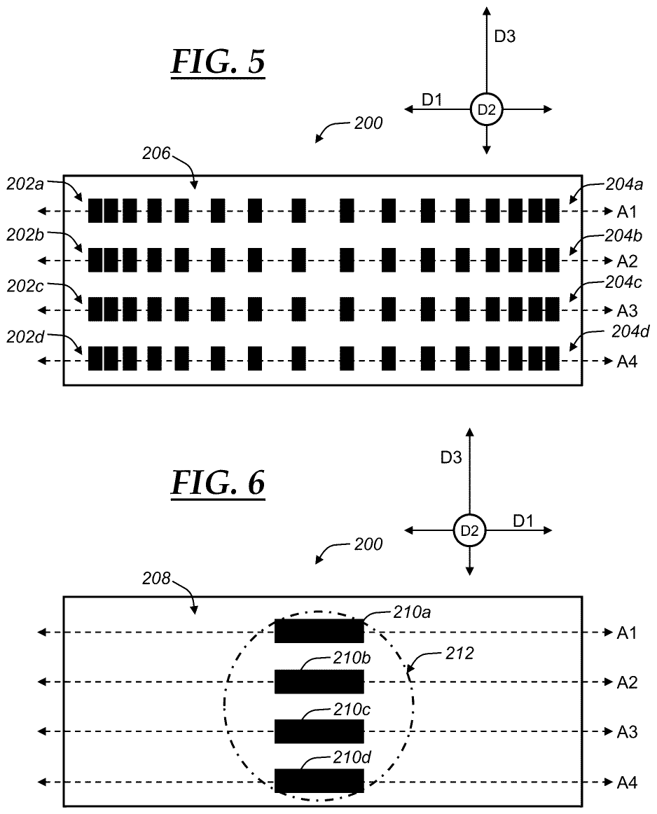

With reference to FIGS. 5 and 6, there is diagrammatically shown two opposing side or peripheral plan views of a three-dimensional (3D) edge-firing OPA 200 with waveguide layers 202a-d, with FIG. 5 depicting an emitter side surface 206 of the OPA 200 and FIG. 6 depicting a collector side surface 208 of the OPA 200, where the emitter side surface 206 and the collector side surface 208 are opposed from one another so that light travels between the two surfaces 206,208 through the waveguide layers 202a-d. The OPA 200 corresponds to the OPA 12 of the OPA device 10, and the discussion of the OPA 12 is hereby incorporated and attributed to the OPA 200 to the extent that discussion is not inconsistent with the discussion of the OPA 200.

In the depicted embodiment, the OPA 200 includes four (4) waveguide layers 202a-d. However, it will be appreciated that the 3D OPA 200 may include any suitable number of waveguide layers, and that the particular number of waveguide layers is selected or determined in accordance with an intended use or application of the OPA. Each of the waveguide layers 202 corresponds to a row or linear array of edge emitters 204a-d. Each row of edge emitters 204a-d extends along a waveguide layer axis A1,A2,A3,A4, respectively, extending in the first dimension D1 and aligned to pass through a center of the respective edge emitters 204a-d taken in the third dimension D3.

FIG. 6 illustrates the collector side surface 208 in plan view, which has a waveguide edge coupling region 212 shown as constituting a circular region of the collector side surface 208. The waveguide edge coupling region 212 includes transmissive portions 210a-d of each of the waveguide layers 202a-d, which are used to transmit light between the waveguide edge coupling region 212 to which the optical fiber 14 is to be coupled and the row of edge emitters 204a-d. In embodiments, the side surfaces, such as the emitter side surface 206 and the collector side surface 208 of the OPA 200, are polished so as to remove errant fabrication artifacts; and, in some embodiments, particular attention is paid to the waveguide edge coupling region 212, notably for forming a smooth, planar surface. The waveguide edge coupling region 212 corresponds to a fiber coupling interface (also referred to as an input coupling interface) between the optical fiber 14 and the collector side surface 208.

In the present embodiment, each of the four waveguide layers 202a-d corresponds to the waveguide layer 100 discussed above, although the single-mode common waveguide path 23 varies in its waveguide pathlength amongst each of the waveguide layers 202a-d, rendering a time delay of light passing therethrough. The waveguide pathlength and, in effect, the time delay of a given waveguide layer (relative to another waveguide layer in the same 3D OPA) is precisely defined for each of the waveguide layers so that a phase shift results amongst the waveguide layers. In the present embodiment, each of the waveguide layers 202a-d has a waveguide pathlength P₂₃ for its single-mode common waveguide path 23 that is different than those of the other waveguide layers, whereby a phase shift is introduced amongst adjacent waveguide layers and/or in a manner such that there is a phase shift introduced amongst each and every pair of waveguide layers, meaning each waveguide layer is at a different phase from one another.

In the present embodiment, delay is introduced between waveguide layers in addition to between emitters of a single waveguide layer. A non-uniform arrangement of emitters was used in each layer, as well as a uniform arrangement in an orthogonal direction, which occurs with cladding between layers. This design facilitates efficient beam steering in both orthogonal directions without the need for additional components, at least according to one embodiment. Such a design not only improves directivity but also produces a point-like output characteristic, significantly enhancing the efficiency of coupling to other optical components. Such an approach is useful for enhancing system performance and versatility, providing a compact and scalable solution for advanced photonics applications.

The performance of an OPA is fundamentally influenced by the interaction of optical fields within each emitter, which collectively define the overall beam emission pattern. Each emitter's amplitude and phase contribute to the final beam trajectory. In multi-dimensional arrays, the combined effect of all emitters determines the direction and shape of the emitted beam. For instance, the emission from an individual emitter can be represented by: Eᵢ(r)=Aᵢe^{φ}^{ᵢ}e^{-jk·r}, where Aᵢ denotes the amplitude of the i-th emitter, φᵢ denotes the phase of the i-th emitter,

$$k = \frac{2 π}{λ}$$

is the wave vector, and r is the spatial vector of the emitter. In two-dimensional (M×N) emitter arrays, the total observed emission at given angular directions (θ,ψ) is expressed as:

$$E ( θ , ψ ) = {\sum }_{m = 1}^{M} {\sum }_{n = 1}^{N} {A}_{mn} {e}^{j ( {kd}_{m} sin ( θ ) cos ( ψ ) + {kd}_{n} sin ( θ ) sin ( ψ ) + Δ {ϕ}_{mn} )} \qquad Equation ( 1 )$$

Beam steering in OPAs typically involves modulating the phase of the light emitted by each element, with the steering angle in phased arrays being controlled by the phase difference between adjacent emitters, which depends on the spacing (pitch) between the waveguides and the applied phase shift.

In regards to beam trajectory modulation for optical beam steering, steering along the θ angle for grating-based emitters can be achieved through wavelength tuning, described by sin

$${θ}_{N} = \frac{Λ \cdot {n}_{eff} - N \cdot λ}{Λ \cdot {n}_{ct}} ,$$

which relates the sine of the Nth order angle θ to the wavelength of light (λ), the effective refractive index of the waveguide (n_{eff}), the refractive index of the background medium (n_{ct}), and the grating period (Λ). Steering along the ψ angle using the phased array principle is given by sin

$$ψ = \frac{{λ}_{0} \cdot Δϕ}{2 π d} ,$$

which relates the sine of the angle ψ to the phase difference (Δφ) between array elements at a specific wavelength (λ₀), with d representing the pitch (center-to-center) distance between adjacent waveguides.

When using a passive phase shifter based on delay lines, the interference pattern, analogous to that observed in a double-slit experiment, where n_{eff}(λ)→L induces a shift in the fringes:

$$d sin ψ = m λ - {n}_{eff} ( λ ) Δ L \qquad Equation ( 2 )$$

In this design, steering is achieved by tuning the wavelength of light, where d is the pitch, ψ is the steering angle, λ is the wavelength of light, ΔL is the delay line, and n_{eff} is the effective refractive index.

In regard to the design, this OPA is designed to enable 2D beam steering by utilizing two distinct delay lengths: one between arrays/emitters within each layer (ΔL₁) and another between corresponding waveguides across different layers (ΔL₂). These delay lengths allow for dual-axis control using only wavelength tuning. Specifically, ΔL₁ enables steering in one direction (the first direction D1, for example), while ΔL₂ enables steering in the orthogonal direction (the third direction D3, for example).

Each layer of the OPA consists of an equal number of waveguides arranged with non-uniform spacing to mitigate sidelobe levels. The differential phase shift Δφ caused by the delay lines is expressed as:

$$Δ ϕ = \frac{2 {πΔ Ln}_{eff} ( λ )}{λ} .$$

Beam steering for one spot width can be calculated by differentiating this phase with respect to the wavelength, resulting in the wavelength step required for the phase shift:

$$Δ λ = \frac{{λ}^{2}}{{Δ Ln}_{eff} ( λ )} .$$

Applying both ΔL₁ and ΔL₂ allows the system to transition from 1D to full 2D beam steering.

The equations for beam steering in the y (the first direction D1) and z directions (the third direction D3) are given by:

$${ψ}_{y / z} ( λ ) = {sin}^{- 1} ( \frac{λ}{d} - \frac{{n}_{eff} ( λ ) Δ {L}_{1 / 2}}{d} ) ,$$

where ΔL₁ and ΔL₂ correspond to the delay line lengths for the respective axes. This configuration enables beam steering in one direction while simultaneously and repeatedly sweeping across a defined range in the orthogonal direction, achieving complete 2D control. To attain faster steering over a specific range, longer delay lines are required. They not only enable rapid steering but also allow for repeated sweeping of the range. This phenomenon arises from the periodic nature of the phase difference introduced by the delay lines. When the delay length ΔL increases, the phase shift n_{eff}(λ)ΔL grows/increases linearly. As this phase shift becomes an integer multiple of the wavelength λ (modulo 2π), it corresponds to the same diffraction order m. This periodicity, occurring at intervals of

$$\frac{λ}{{n}_{eff} ( λ )} ,$$

means that increasing ΔL leads to the recurrence of specific steering angles.

To optimize the pitch size and minimize side-lobe levels, employed a genetic algorithm (GA) was employed in the present embodiment, although other algorithms may be employed in other embodiments. The GA was initialized with a population of 50 individuals, each representing a set of pitch sizes, and evolved over 100 generations to find the configuration that minimized the side-lobe suppression ratio (SLSR). A crossover probability of 0.7 and a mutation probability of 0.3 were used to balance exploration and exploitation. Tournament selection with a size of 3 was utilized to select the fittest individuals, providing moderate selection pressure while preserving population diversity and preventing premature convergence. On the other hand, this design also offers the advantage of enabling positive or negative phase profile slopes by varying the gradient, i.e., the order of ΔL between layers. The beam steers in different directions depending on the phase gradient, as constructive interference occurs along the direction of the phase gradient.

In the present embodiment, silicon (Si) is used as the waveguide material and silicon dioxide (SiO₂) as the cladding material, where silicon's high refractive index (˜3.45 at 1550 nm) ensures strong optical confinement, enabling compact and efficient design while its transparency in the near-infrared region makes it ideal or otherwise quite useful for optical communications. Moreover, silicon's compatibility with CMOS technology allows for cost-effective, scalable fabrication.

Silicon dioxide, with a lower refractive index (˜1.44 at 1550 nm), provides excellent cladding to keep light confined within the waveguide. The effective index (n_{eff}) of a single-mode silicon waveguide (500 nm width, 220 nm thickness) is approximately 2.5 at 1500 nm and 2.39 at 1600 nm. Across the wavelength range, n_{eff} for Si remains higher than that of Si₃N₄, enabling nearly double the phase shift for the same delay length. As a result, the delay length can be halved with silicon, enhancing performance and compactness. Even with Si₃N₄ emitters, silicon remains superior for phase shifting.

According to one embodiment, an eight waveguide layer OPA is constructed so as to have a common delay for each layer that is different than the other waveguide layers. In some embodiments, the length of delay (being set from the shortest time travel within the single-mode common waveguide path amongst the waveguide layers) and, starting from a no-common-delay waveguide layer, increases for each layer so that the first layer has no single-mode common delay and the last layer has the largest single-mode common delay amongst the waveguide layers.

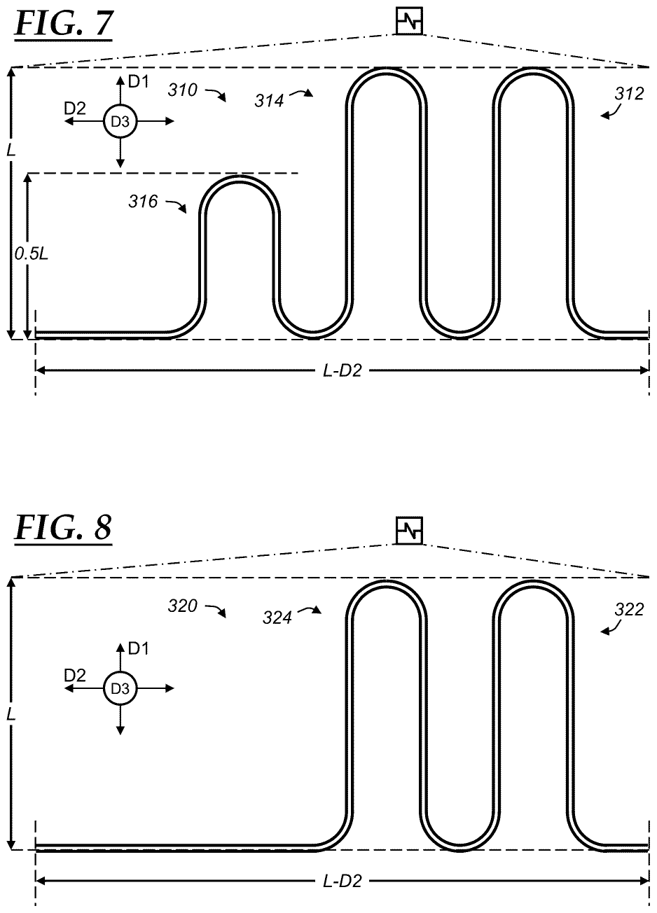

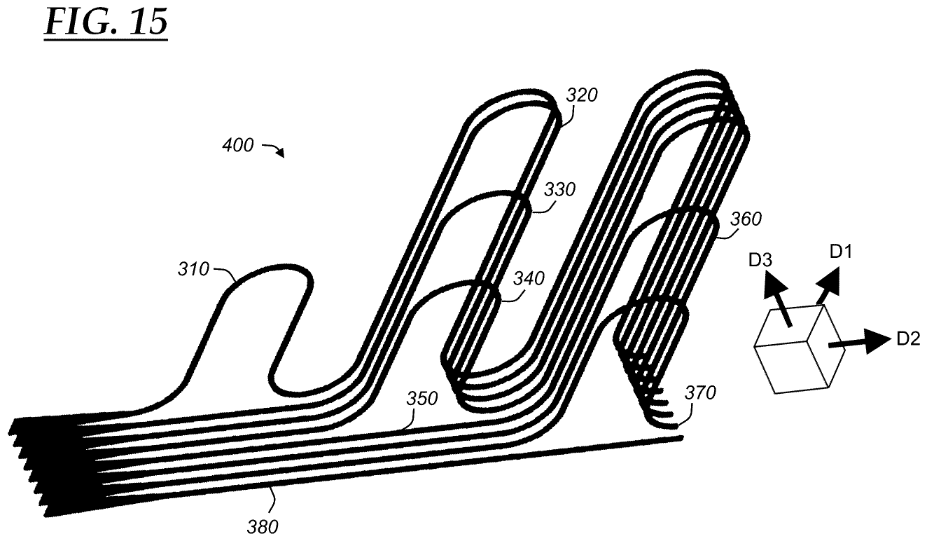

With reference now to FIGS. 7-15, there is provided an eight waveguide layer OPA 400 having a plurality of waveguide layers each with a different single-mode common waveguide configuration, each of which is shown individually in a respective one of FIGS. 7-14. The discussion of the OPA 12 and other features of the OPA 12 or the OPA 200 are hereby incorporated and attributed to the OPA 400 to the extent such discussion is not inconsistent with the teachings of the OPA 400.

Each of the eight waveguide layers of the OPA 400 includes a common waveguide portion in which light for all of the emitters in the waveguide layer propagates together and an individual or arrayed waveguide portion in which the light is split or bifurcated (one or more times) into a plurality of individual waveguide portions, each of which corresponds to and is terminated at an emitter of the waveguide layer. In the present embodiment discussed below in connection with the OPA 400, each of the eight waveguide layers includes eight waveguide paths and corresponding emitters arranged in a linear array, and these eight waveguide paths result from a MMI or tree splitter interposed between a single-mode common waveguide portion and the individual waveguide paths.

In the design of the present embodiment, the θ direction is used for slow-axis sweeping, achieved by employing shorter delay lines between the waveguides in each layer. For the ψ direction, which is used for fast-axis sweeping, longer delay lines are implemented between waveguides in different layers. This delay can either be introduced only in the Ω-shaped part or in two stages: first, between the taper and the Y-splitter, and second, in an Ω-shaped configuration. The second approach helps prevent the enlargement of the device, maintaining a compact footprint for larger delay lengths.

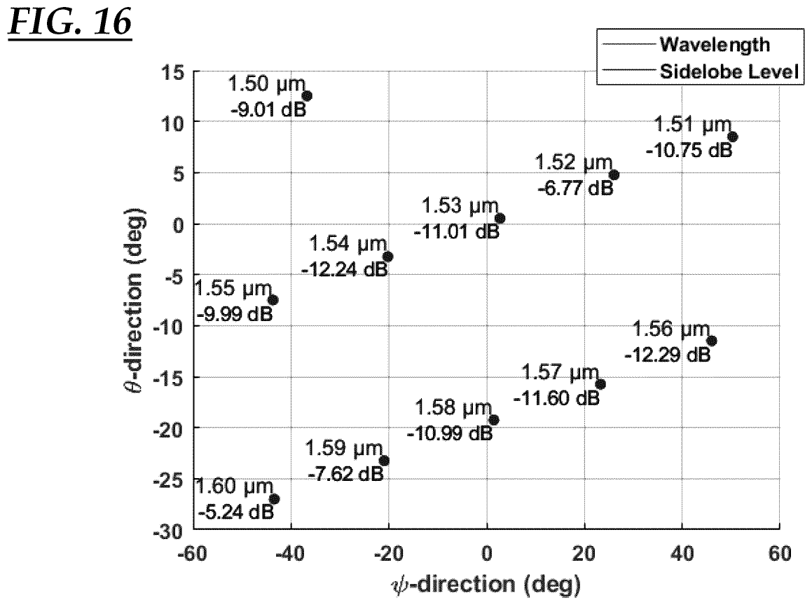

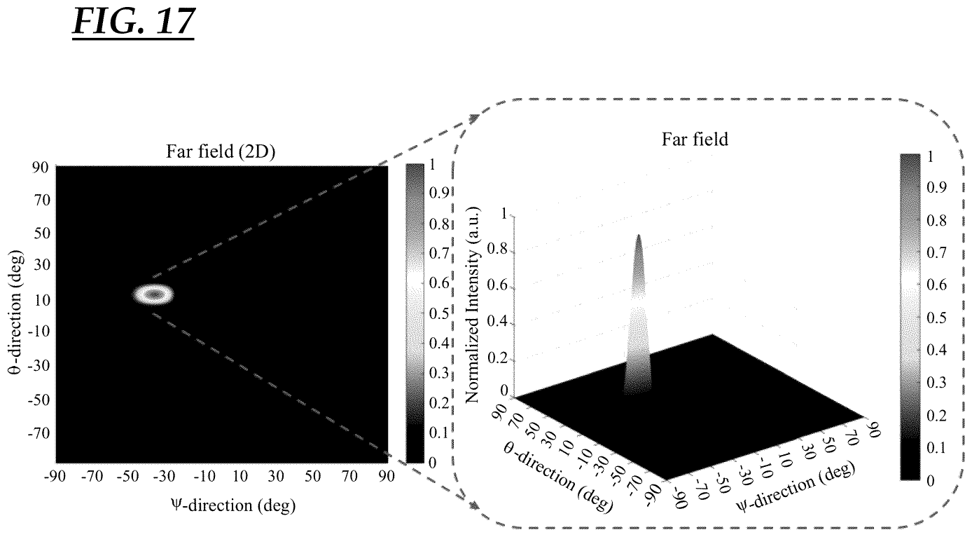

According to one embodiment, the design of the present embodiment is characterized by a ΔL₁ of 5 μm, and achieves a maximum steering angle of 39.5 degrees in the θ direction (corresponding to the first direction D1) within a wavelength tuning range of 110 nm. In the ψ direction (corresponding to the third direction D3), with a ΔL₂ of 20 μm, the design of the present embodiment achieves a maximum steering angle of 89.5 degrees with a 40 nm wavelength sweep. Exemplary results are shown in FIG. 16, which shows steering performance in two orthogonal directions. Each data point corresponds to the main lobe for a specific wavelength, spanning from 1500 nm to 1600 nm. Each point in FIG. 16 corresponds to a far-field point, as illustrated in FIG. 17, which is an exemplary graph that serves as an example, displaying the farfield in both 2D and 3D perspectives for a 1500 nm wavelength.

In the design of the present embodiment, a non-uniform pitch was employed for the waveguides in each layer to mitigate side lobe levels, with a genetic algorithm (GA) identifying the optimal configuration. In the present embodiment, For Si waveguides, the pitch ranged from 1.7 μm to 2.5 μm, while for Si₃N₄ waveguides, the range was 3 μm to 5 μm. It was found that these GA-optimized values consistently achieved lower side-lobe levels compared to uniform configurations. The GA setup evaluated seven pitch values corresponding to eight waveguides per array, with the fitness function assessing the Side Lobe Suppression Ratio (SLSR) based on far-field simulations. Tournament selection was employed to balance convergence speed and population diversity, while crossover and mutation operations further refined the pitch values. The GA iteratively called Lumerical™ simulations to analyze farfield patterns, storing results for side lobe analysis until convergence on the optimal configuration. This non-uniform approach effectively reduced side lobes and minimized crosstalk while adhering to fabrication constraints. For inter-layer waveguides, a uniform pitch of 1.5 μm (for Si₃N₄) and 1.2 μm (for Si) was employed, determined by the cladding thickness.

For all simulations that were performed, the refractive indices of Si and SiO₂ were chosen from the Lumerical™ material library (Ansys Inc.). A finite-difference eigenmode (FDE) solver was used to identify the effective refractive indices and mode field profiles for the theoretical calculations. All other simulations were conducted using a three-dimensional (3D) finite-difference time domain (FDTD) method from Ansys Lumerical™, as well as Omnisim™ software. The GA employed in this work was configured with a population size of 50 individuals and evolved over 100 generations. Tournament selection was used, with a tournament size of 3, to maintain a balance between selection pressure and diversity. A crossover probability of 0.7 facilitated the recombination of solutions, while a mutation probability of 0.3 introduced sufficient randomness to explore new areas of the search space. The fitness function was designed to minimize the side-lobe suppression ratio (SLSR), with a threshold of −5 dB to identify high-quality solutions. Of course, simulations using other parameter values, techniques, and implements may be employed.

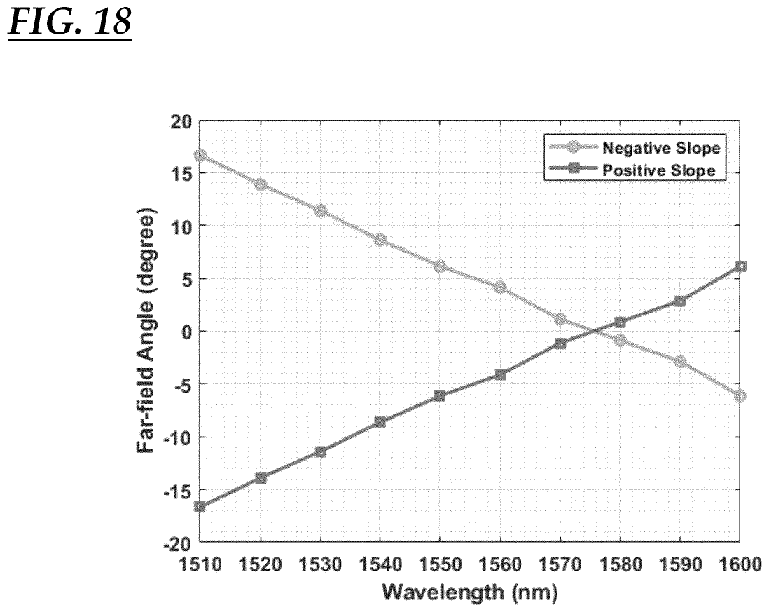

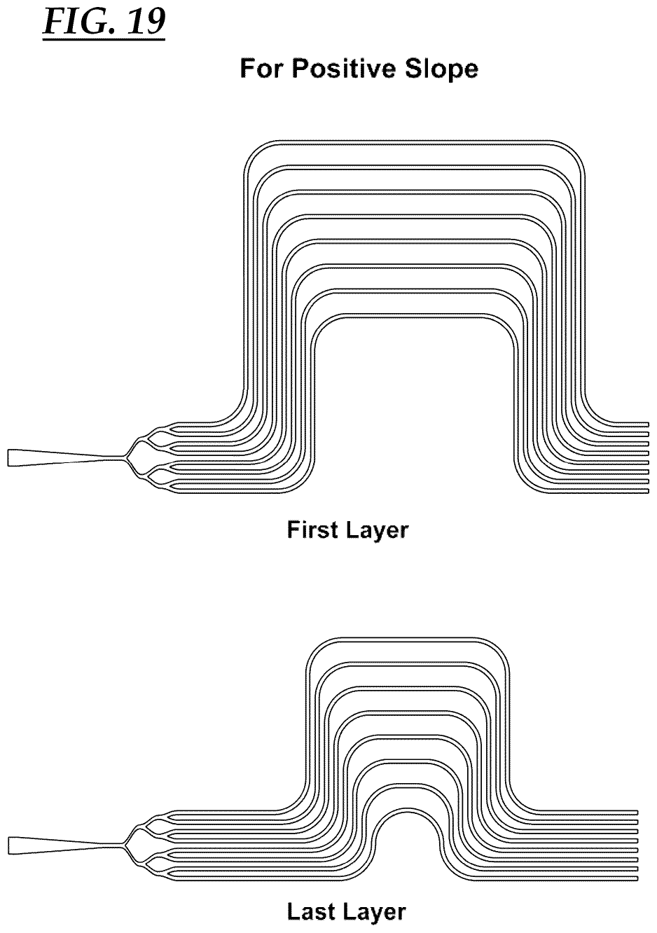

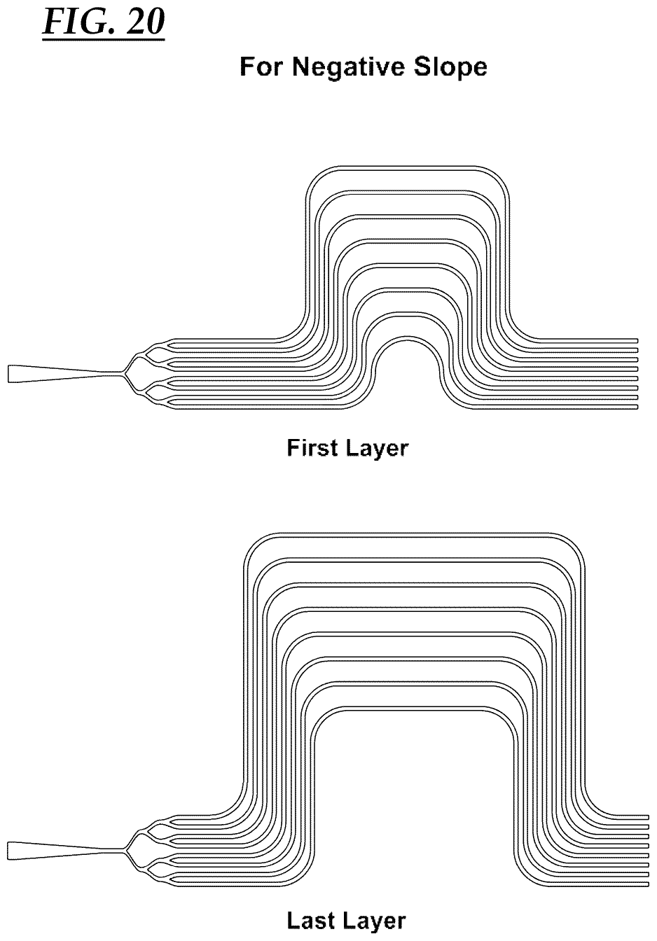

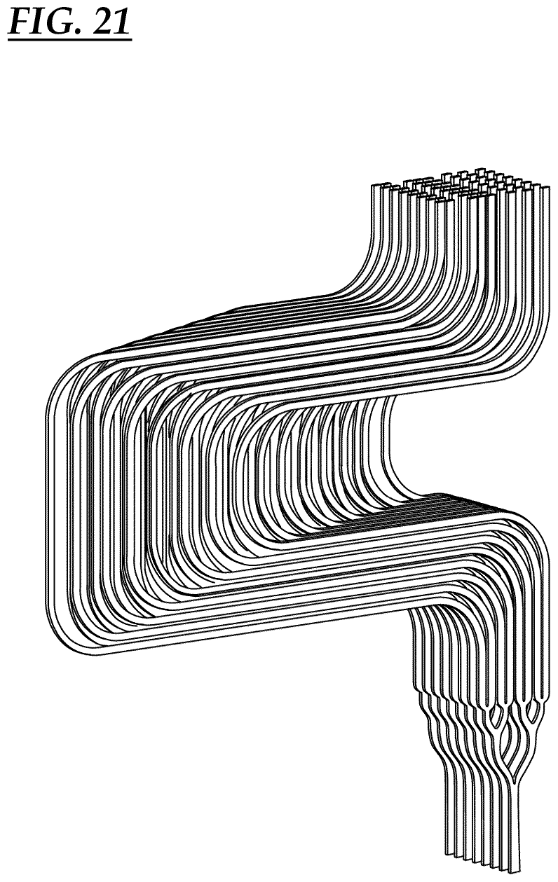

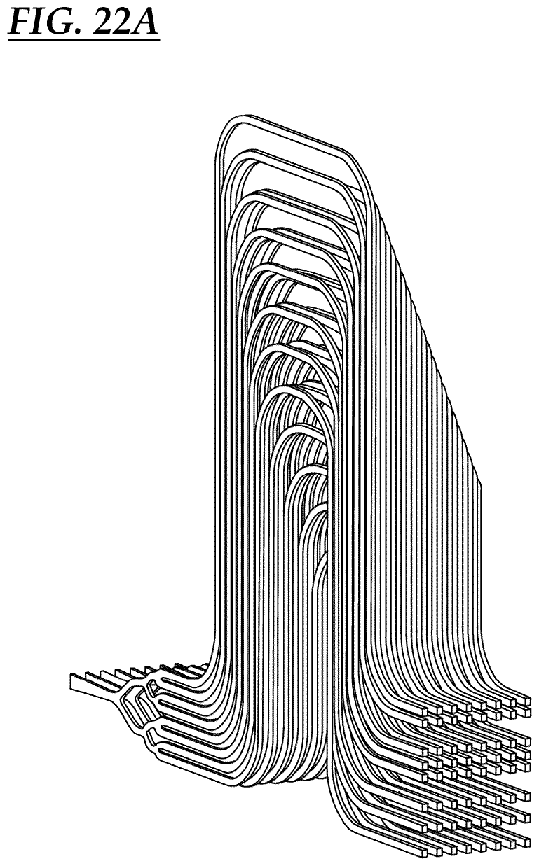

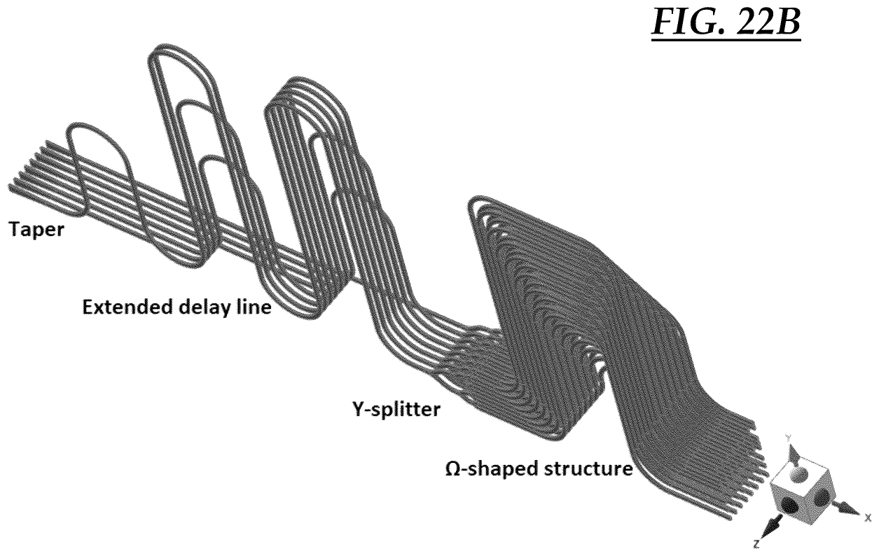

With reference now to the approach shown in FIGS. 18-22B, another advantage of this design of the present embodiment is the possibility of designing for either negative or positive vertical phase profile slopes, which is not possible with a grating-based emitter design. In FIG. 18, there is shown a graph of wavelength (in nm) (on the x axis) and farfield angle (in degrees) (on the y axis) and, in FIGS. 19 and 20, there is shown a plan view of an inter-emitter delay portion of a different first and a last waveguide layer for a positive slope (FIG. 19) and a plan view of an inter-emitter delay portion of a different first and a last waveguide layer for a positive slope (FIG. 20). With this approach, two identical and symmetric beams in two different directions is achievable. FIGS. 21 and 22A-B depict isometric, perspective views of an individual waveguide delay portion of a positive-slope 3D OPA in which a plurality of individual waveguide paths N are shown for each of the M waveguide layers, which is 8 (M=8) in the depicted embodiment of FIGS. 21 and 22A-B. The plurality of individual waveguide paths shown in FIGS. 21 and 22 provide an example of an OPA with a positive vertical phase profile slope.

With specific reference now to FIGS. 7-14, there are shown eight (8) variations of a single-mode common waveguide path, each of which may be used as the single-mode common waveguide path 23 in a given waveguide layer. According to a present embodiment discussed in regards to FIGS. 7-14, a 3D OPA is provided with eight waveguide layers in a stacked arrangement such that each waveguide layer, which is planar in form, is adjacent at least one other waveguide layer in a sandwich or layered manner, such as is diagrammatically shown in the embodiment of FIGS. 5-6 (although with eight layers in the present embodiment). Each of the eight waveguide layers includes a single-mode common waveguide path 23 corresponding to a different one of the single-mode common waveguide paths 23-1 to 23-8 (where 23-m is the m-th single-mode common waveguide path, where m is an index being an integer between 1 and M, where M is an integer equal to the number of waveguide layers of the 3D OPA).

Each of FIGS. 7-14 depicts a different waveguide path configuration, including seven different delay waveguide path configurations 310,320,330,340,350,360,370 (FIGS. 7-13) and a no-delay waveguide path configuration 380 (FIG. 14), where each of the delay waveguide path configurations 310,320,330,340,350,360,370,380 is used for the path 23-m of a different one of the waveguide layers of the 3D OPA. In the present embodiment, the first waveguide path configuration 310 is used for a top waveguide layer of the 3D OPA, the eighth waveguide path configuration 380 being used for a bottom waveguide layer of the 3D OPA, and the other six layers being interposed therebetween in a stacked manner.

With specific reference now to FIG. 7, there is shown a single-mode common waveguide configuration 310, which may be used for the path 23-1 of a first waveguide layer of the eight layer OPA of the present embodiment. The single-mode common waveguide configuration 310 of FIG. 7 includes three distinct delay portions 312-316, including a first delay portion 312, a second delay portion 314, and a third delay portion 316. Each of the first delay portion 312 and the second delay portion 314 extends in the first direction D1 for a distance of a length L whereas the third delay portion 316 extends in the first direction D1 for a distance or length taken in the first direction D1 (referred to as a first direction delay distance or length) as 0.5 L. For a set of M different single-mode common waveguide configurations that are to be used or are used in a 3D OPA, the length L is the furthest distance that any of delay portion extends away from a collector-side end of the single-mode common waveguide path 23-m, as measured or taken in the first direction as shown in FIGS. 7-13. In the present embodiment, the first delay portion 312 and the second delay portion 314 are full-length delay portions as their first direction delay distance is the largest of the delay portions of the 3D OPA. The third delay portion 316 is a half-length delay portion as its first direction delay distance is 0.5 L, and also is considered a medium delay portion in that the first direction distance is between forty and seventy percent (40-70%, inclusive) of the longest first direction delay distance L.

With specific reference now to FIG. 8, there is shown a single-mode common waveguide configuration 320, which may be used for the path 23-2 of a second waveguide layer of the eight layer OPA of the present embodiment. The single-mode common waveguide configuration 320 of FIG. 8 includes two distinct delay portions 322,324, including the first delay portion 322 and the second delay portion 324. More particularly, the first delay portion 322 and the second delay portion 324 are full-length delay portions as their first direction delay distance is the largest of the delay portions of the 3D OPA.

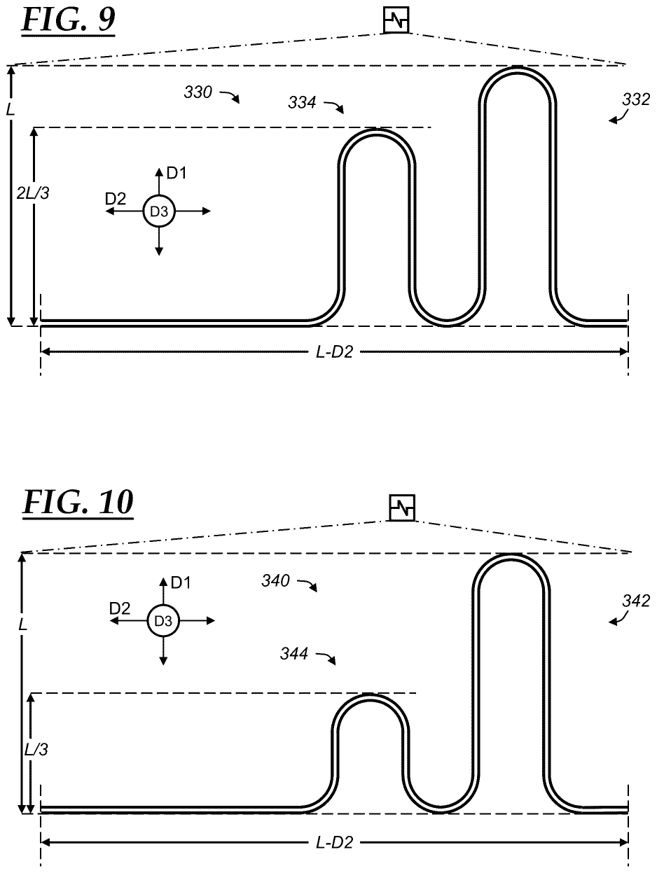

With reference to FIG. 9, there is shown a single-mode common waveguide configuration 330, which may be used for the path 23-3 of a third waveguide layer of the eight layer OPA of the present embodiment. The single-mode common waveguide configuration 330 of FIG. 9 includes two distinct delay portions 332,334, including the first delay portion 332 and the second delay portion 334. More particularly, the first delay portion 332 is a full-length delay portion as its first direction delay distance is the largest of the delay portions of the 3D OPA. The second delay portion 334 is a medium-length delay portion as its first direction delay distance is 2 L/3 (two-thirds of L).

With reference to FIG. 10, there is shown a single-mode common waveguide configuration 340, which may be used for the path 23-4 of a fourth waveguide layer of the eight layer OPA of the present embodiment. The single-mode common waveguide configuration 340 of FIG. 10 includes two distinct delay portions 342,344, including the first delay portion 342 and the second delay portion 344. More particularly, the first delay portion 342 is a full-length delay portion as its first direction delay distance is the largest of the delay portions of the 3D OPA. The second delay portion 344 is a short-length delay portion as its first direction delay distance is L/3 (one-third of L) is less than forty percent (<40%) of the longest first direction delay distance L.

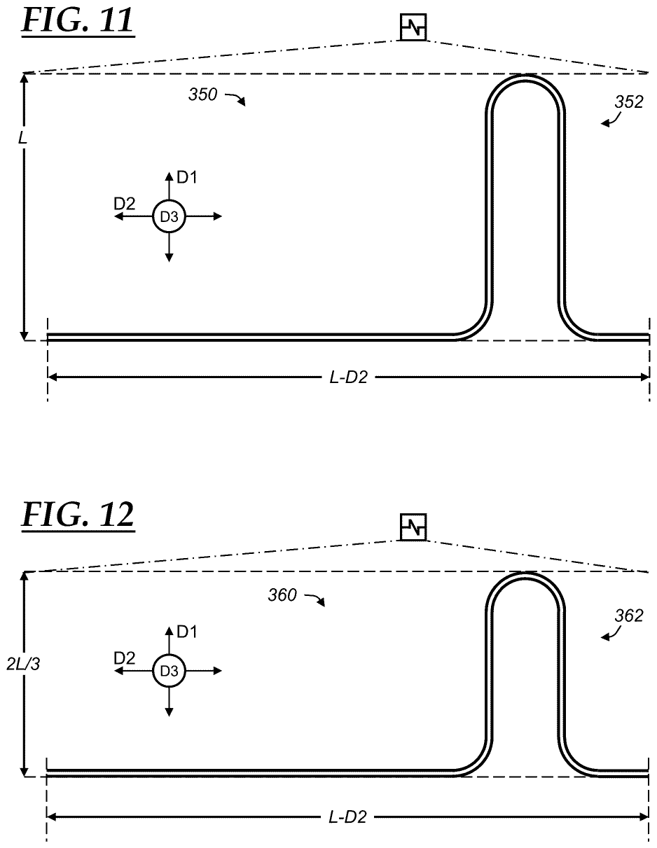

With reference to FIG. 11, there is shown a single-mode common waveguide configuration 350, which may be used for the path 23-5 of a fifth waveguide layer of the eight layer OPA of the present embodiment. The single-mode common waveguide configuration 350 of FIG. 11 includes a single distinct delay portion 352, which is a full-length delay portion as its first direction delay distance is L.

With reference to FIG. 12, there is shown a single-mode common waveguide configuration 360, which may be used for the path 23-6 of a sixth waveguide layer of the eight layer OPA of the present embodiment. The single-mode common waveguide configuration 360 of FIG. 12 includes a single distinct delay portion 362, which is a medium-length delay portion as its first direction delay distance is 2 L/3.

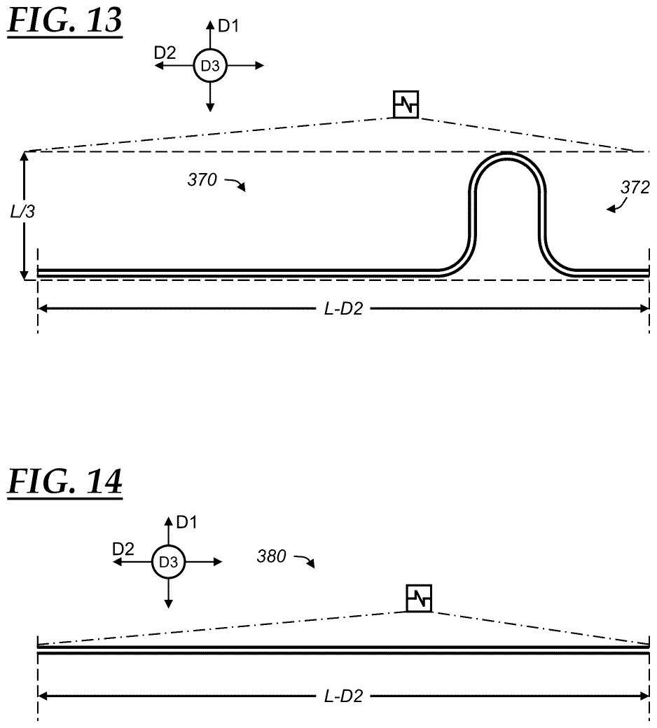

With reference to FIG. 13, there is shown a single-mode common waveguide configuration 370, which may be used for the path 23-7 of a seventh waveguide layer of the eight layer OPA of the present embodiment. The single-mode common waveguide configuration 370 of FIG. 13 includes a single distinct delay portion 372, which is a short-length delay portion as its first direction delay distance is L/3.

With reference to FIG. 14, there is shown a single-mode common waveguide configuration 380, which may be used for the path 23-8 of a eighth waveguide layer of the eight layer OPA of the present embodiment. The single-mode common waveguide configuration 380 of FIG. 14 includes no distinct delay portions and is a no-delay single-mode common waveguide configuration, which is considered as having a delay of zero (0) (no delay) relative to the other seven layers of the eight layer OPA.

A multi-layer OPA with a nonuniform pitch size between arrays in each layer and a uniform arrangement between layers is provided, and this OPA of the present embodiment is designed for dual-axis beam steering on a Si/SiO₂ platform. At least in embodiments, by integrating passive phase shifters based on delay lines across multiple layers, the OPA of the present embodiment achieves precise control and wide-angle steering in two orthogonal directions. Numerical simulations validate the effectiveness of this approach. Additionally, by eliminating the need for grating couplers, the design of the present embodiment simplifies the system architecture and beam steering control. Additionally, according to at least some embodiments, this approach allows for the manipulation of phase profile slopes, enabling both positive and negative slopes through delay line gradients between layers.

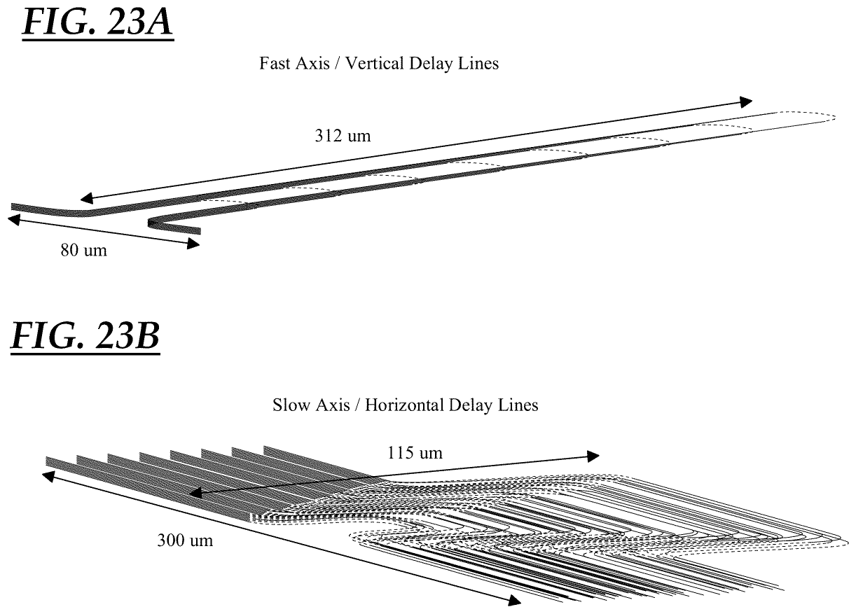

With reference now to FIGS. 23A-B, there are shown embodiments of a vertical delay line, corresponding to delay in the third dimension D3 (fast axis) (FIG. 23A), and of a horizontal delay line, corresponding to delay in the first dimension D1 (slow axis) (FIG. 23B). The vertical delay line of FIG. 23A is shown as extending in the first dimension D1 for a maximum distance of 312 μm and spanning 80 μm in the second dimension D2. The horizontal delay line of FIG. 23B is shown as extending in the first dimension D1 for a maximum distance of 115 μm and spanning 300 μm in the second dimension D2. It will be appreciated that the values and other characteristics of the vertical delay line and the horizontal delay line of FIGS. 23A-B are exemplary, as other values may be used in different embodiments, as would be appreciated by a person skilled in the art in light of the discussion herein.

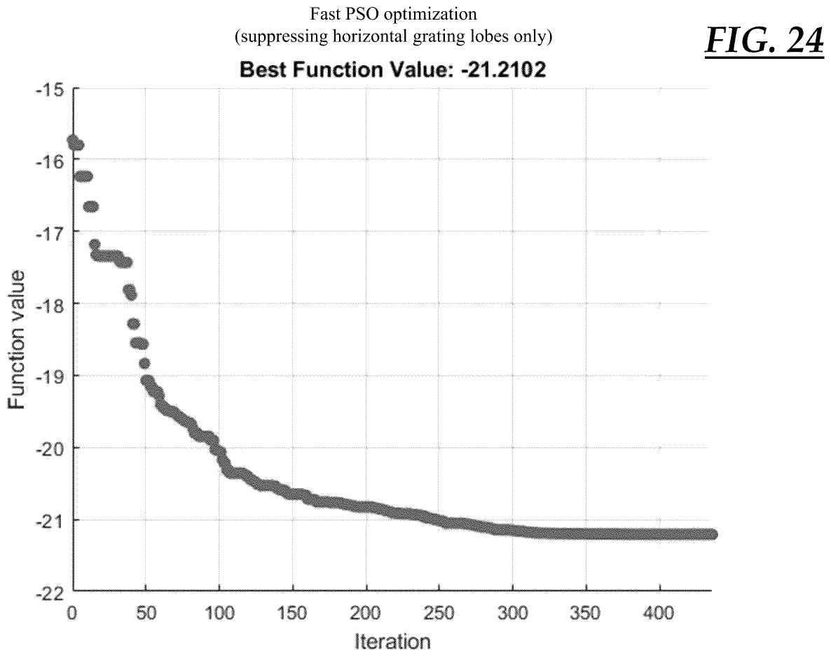

With reference now to FIG. 24 there is shown a graph illustrating a function value for each of about 450 iterations of a particle swarm optimization (PSO), particularly a fast PSO used for suppressing horizontal grating lobes or those corresponding to ones observed in the plane defined by the first dimension D1 and the second dimension D2 (referred to as the “horizontal plane”). The best function value is approximated as −21.2102 as shown in FIG. 24, and this is used for determining emitter pitch of emitters within a waveguide layer of an optical phased array.

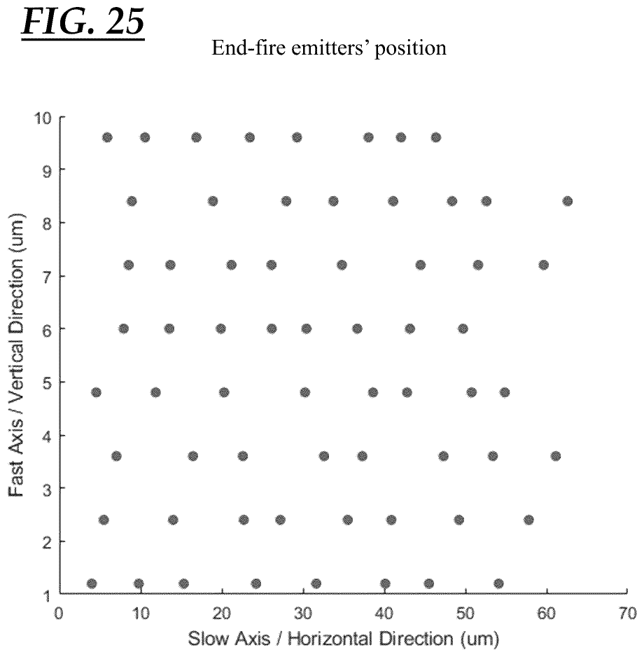

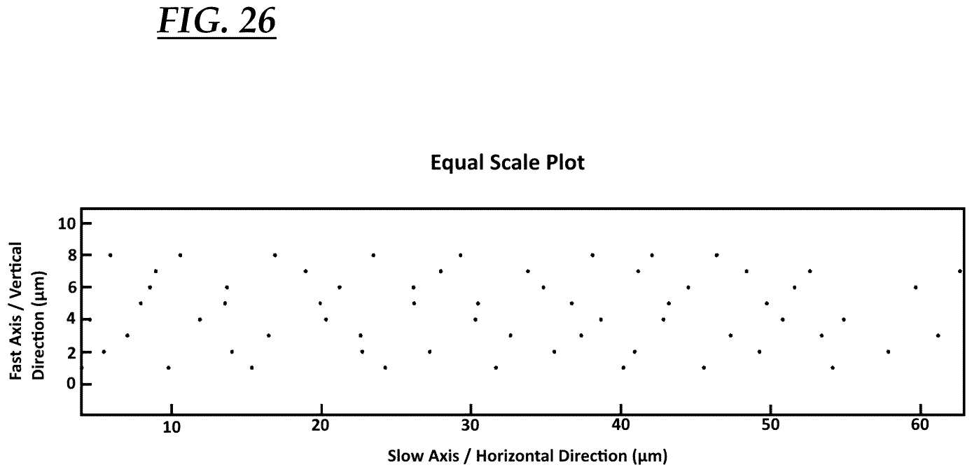

With reference now to FIGS. 25-26, there are shown two versions of a spatial graph illustrating emitter positions of an eight (8) waveguide layer OPA, with the x-axis corresponding to a slow axis or horizontal direction (dimension D1) and the y-axis corresponding to a fast axis or vertical direction (dimension D3). The units of the distances of FIGS. 25-26 are in micrometers (μm). FIG. 26 is an equal scale plot of FIG. 25, where the scales for the x-axis and γ-axis are set to be equal.

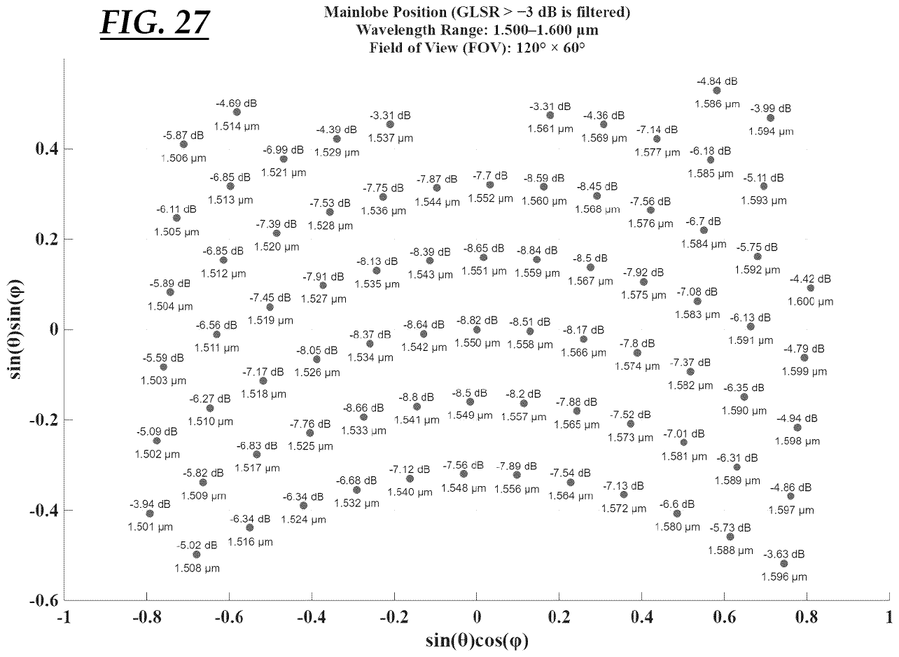

With reference now to FIG. 27, there is shown a graph, particularly a radiation intensity pattern plot for a 3D OPA operating with a field of view (FOV) angular range of 120°× 60° (120° for horizontal, 60° for vertical). Each point represents the far-field radiation intensity at a specific angular coordinate, with the point's color corresponding to the wavelength in micrometers (μm) and the label denoting the associated side-lobe level (dB). Mainlobe position is determined referencing FIG. 27, which has grating lobe suppression ratio (GLSR) of −3 decibels (dB).

It will be appreciated that the figures indicate orientation relative to three dimensions, a first dimension D1, a second dimension D2, and a third dimension D3, which are all orthogonal to one another and that may correspond to Y, X, and Z axes, respectively.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. An optical phased array (OPA), comprising a first waveguide layer and a second waveguide layer, wherein each of the first waveguide layer and the second waveguide layer has a single-mode common waveguide path connected to a plurality of emitters, and wherein the single-mode common waveguide path of the second waveguide layer is delayed relative to the single-mode common waveguide path of the first waveguide layer.

2. The OPA of claim 1, wherein an inter-emitter delay is provided between adjacent ones of the plurality of emitters of the second waveguide layer so as to cause a phase shift between the adjacent ones of the plurality of emitters.

3. The OPA of claim 1, wherein the single-mode common waveguide path of the first waveguide layer is a no-delay single-mode common waveguide path, and wherein the single-mode common waveguide path of the second waveguide layer is a delay single-mode common waveguide path that is delay according to a first delay amount.

4. The OPA of claim 3, further comprising a third waveguide layer having a single-mode common waveguide path connected to a plurality of emitters, wherein the second waveguide layer is interposed in a stacked manner between the first waveguide layer and the third waveguide layer, and wherein the single-mode common waveguide path of the third waveguide layer is a delay single-mode common waveguide path that is delay according to a second delay amount that is more than the first delay amount.

5. An OPA device, comprising the OPA of claim 1.

6. A lidar device, comprising:
the OPA of claim 1;
an optical fiber for coupling to the OPA so as to be in optical communication with a multi-mode common path of each of the first waveguide layer and the second waveguide layer; and
a light sensor coupled to the optical fiber and configured for optical communication with the plurality of emitters of each of the first waveguide layer and the second waveguide layer.

7. The OPA of claim 1, wherein the single-mode common waveguide path of the second waveguide layer includes an extended delay line that extends in a second direction orthogonal to the first direction.

8. A lidar device, comprising:
an optical phased array (OPA) having a first waveguide layer and a second waveguide layer;
an optical fiber for coupling to the OPA so as to be in optical communication with a common path of each of the first waveguide layer and the second waveguide layer; and
a light sensor coupled to the optical fiber and configured for optical communication with the plurality of emitters of each of the first waveguide layer and the second waveguide layer;
wherein light propagating through the common path of the second waveguide layer is delayed relative to light propagating through the common path of the first waveguide layer.

9. An optical phased array (OPA), comprising:
a first waveguide layer having a first plurality of emitters arranged in a linear array with each emitter of the first plurality of emitters being in optical communication with a common waveguide path of the first waveguide layer via an individual waveguide path of the first waveguide layer; and
a second waveguide layer having a second plurality of emitters arranged in a linear array with each emitter of the second plurality of emitters being in optical communication with a common waveguide path of the second waveguide layer via an individual waveguide path of the second waveguide layer;
wherein the common waveguide path of the second waveguide layer is delayed relative to the common waveguide path of the first waveguide layer.

10. An optical phased array (OPA), comprising a plurality of waveguide layers used for forming a two-dimensional emitter array at a common edge or side of the OPA, wherein the OPA is configured with a first steering angle for steering light in a first direction and a second steering angle for steering light in a second direction, wherein the first direction is orthogonal to the second direction, and wherein the first steering angle and the second steering angle at each at least 35 degrees.

11. The OPA of claim 10, wherein the first steering angle is at least 38 degrees, and wherein the second steering angle is at least 70 degrees.

12. The OPA of claim 10, wherein the first steering angle is at least 38 degrees, and wherein the second steering angle is at least 85 degrees.

13. A method of manufacturing an optical phased array (OPA), comprising:
identifying whether a negative vertical phase profile or a positive vertical phase profile is to be used;
determining a common waveguide path delay amount of a common waveguide path of a second waveguide layer based on whether a negative vertical phase profile or a positive vertical phase profile is to be used, wherein the common waveguide path delay amount of a second waveguide layer is an indication of an amount of delay experienced between light travelling through the common waveguide path of the second waveguide layer and light travelling through the common waveguide path of the first waveguide layer; and
manufacturing an OPA according to the common waveguide path delay amount.
